(19) United States
(12) Patent Application Publication
(10) Pub. No.: US 2019/0241285 A1
(43) Pub. Date: Aug. 8, 2019

(54) MULTI-STAGE, LIQUID HYDROGEN-BASED AEROSPACE SYSTEM

(71) Applicant: Global Reach Aerospace LLC, Austin, TX (US)

(72) Inventor: Preston Henry Carter, Austin, TX (US)

(21) Appl. No.: 16/269,362

(22) Filed: Feb. 6, 2019

Related U.S. Application Data
(60) Provisional application No. 62/626,977, filed on Feb. 6, 2018.
(60) Provisional application No. 62/634,281, filed on Feb. 23, 2018.
(60) Provisional application No. 62/634,297, filed on Feb. 23, 2018.

(51) Int. Cl. B64G 1/00; B64G 1/40; F02K 7/16

(52) U.S. Cl. CPC B64G 1/005; F02K 7/16; B64G 1/401

(57) ABSTRACT

Provided are methods and systems for a modular multi-stage aerospace system having a first-stage vehicle that lifts and accelerates and is capable of achieving velocities of Mach 2.5, the first-stage vehicle powered by at least one turbine engine, and capable of autonomous and remote control; and a second-stage atmospheric flight vehicle capable of velocities of Mach 5.0, the second-stage atmospheric flight vehicle powered by at least one hydrogen-fueled turboramjet engine, and capable of carrying an internal payload; wherein the first-stage vehicle is adapted to support the second-stage atmospheric flight vehicle, as the first-stage vehicle reaches velocities sufficient to launch the second-stage atmospheric flight vehicle, and the second-stage atmospheric flight vehicle is capable of travel 12,000 miles.

### CROSS REFERENCE TO RELATED APPLICATIONS

This application claims priority to U.S. Provisional Application No. 62/626,977, filed Feb. 6, 2018, entitled MULTI-STAGE, LIQUID HYDROGEN-BASED AEROSPACE SYSTEM, U.S. Provisional Application No. 62/634,892, filed Feb. 23, 2018, entitled LARGE TEST AREA COMPRESSED AIR WIND TUNNEL, and U.S. Provisional Application No. 62/634,297 entitled SUPERSONIC HYDROGEN FUEL TURBOJET ENGINE, filed Feb. 23, 2018.

### BACKGROUND

### 1. Field

The present disclosure relates generally to aerospace technology and, more specifically, to multi-stage, liquid hydrogen-based aerospace systems.

### 2. Description of the Related Art

High-speed travel within the atmosphere is rare and expensive, and space is beyond the reach of all but the most well-funded companies and nations. This is due to both the challenging physics of these endeavors and, of particular relevance, the relatively high-cost of iterating to explore the design space for high-speed aerospace vehicles. Many candidate components of aerospace systems have been proposed and some have been tested. However, testing integrated combinations of systems in real world conditions can cost hundreds of millions of dollars, or more. And candidate designs are many. A sampling of parameters in the design space include whether to use solid-fuel rockets or liquid-fuel rockets, disposable vehicles or reusable vehicles, ground-launch or air-launch, airbreathing engines or engines which require oxidizer, single or combined-cycle combustion, single or multi-stage vehicles, fuel type, and so on. The set of permutations in which various options might be combined is quite large.

Many designers have failed to analyze the problem of air and space travel holistically and, as a result, traditional systems are often optimized with components which perform well in one realm (e.g., at subsonic speeds, low in the atmosphere) but are of little use in other realms (e.g., at supersonic or hypersonic speeds, high in the atmosphere). Indeed, after more than a half century of work, no comprehensive solution has been devised which: 1) is relatively inexpensive to build and maintain; 2) is economically feasible to operate on a private commercial basis; 3) allows for short turn-around between flights (e.g., as in an airliner at a gate versus the stacking of a rocket for a vertical launch); 4) carries a sufficient number of passengers and/or freight (i.e., has an adequate payload mass fraction); 5) operates as a high enough speed to be useful given the spherical dimensions of the Earth; 6) operates at a high enough altitude such that sonic boom is minimal at the Earth's surface; 7) consumes an environmentally desirable, affordable, and useful fuel; 8) incorporates certain currently available materials to optimize for cost and proven reliability, and 9) utilizes a platform versatile enough to be capable of launching from a commercial length runway for either point-to-point travel high within the atmosphere, or for access to space.

### SUMMARY

The following is a non-exhaustive listing of some aspects of the present techniques. These and other aspects are described in the following disclosure.

Some aspects of the aerospace system include a two-stage air transportation system providing for travel between any two points on the globe within four-hours or less (antipodal), utilizing a first-stage vehicle powered by turbojet engines fitted with mass injection pre-compressor cooling, wherein such first-stage vehicle lifts and accelerates a second-stage vehicle to Mach 2.50, at which point the second-stage vehicle separates and continues to accelerate under its own power to a velocity of up to Mach 5.00 using hydrogen-fueled turboramjet engines.

Some aspects of the aerospace system include a two or three-stage space access system, wherein a second-stage rocket powered space flight vehicle is launched from the above-described first-stage vehicle, wherein such first-stage vehicle lifts and accelerates the rocket powered space flight vehicle to Mach 2.50, at which point it separates and continues to accelerate under its own power until attaining Earth orbit. For heavier payloads, a rocket booster element can be added to provide additional thrust. For longer missions an on-orbit fuel depot can added to extend the times between which the space flight vehicle needs to return to Earth.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates an example of a system of aerospace vehicles in accordance with some embodiments of the present techniques.

FIG. 2 illustrates a typical flight plan of an atmospheric flight in accordance with certain embodiments of the present disclosure, including an take off and acceleration stage and an atmospheric cruising stage.

FIG. 3 illustrates a typical plan of a combined atmospheric flight and space flight in accordance with certain embodiments of the present disclosure, including a take-off and acceleration stage and a space flight stage.

FIG. 4 illustrates a typical plan of a combined multi-stage space flight in accordance with certain embodiments of the present disclosure, including a take-off and acceleration stage, a booster stage, and a space flight stage.

While the present techniques are susceptible to various modifications and alternative forms, specific embodiments thereof are shown by way of example in the drawings and will herein be described in detail. The drawings may not be to scale. It should be understood, that the drawings and descriptions thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of aerospace and propulsion engineering. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some embodiments exploit a heretofore unexplored envelope in the above-described design space that is expected to afford relatively low-cost high-speed air travel within the atmosphere, as well as low-cost and rapid access to space. Some embodiments provide a solution closer to an overall optimum for the larger set of issues that arise when both high-speed flight within the atmosphere (up to and including Mach 5.00) and access to space are undertaken. To this end, some embodiments of the aerospace system implement a particular mix of different classes of vehicles which, as a system, are expected to provide at least one, and in certain embodiments both, of the following:

a. Air travel, between any two points on the globe within four-hours or less (antipodal), utilizing a first-stage vehicle powered by turbojet engines fitted with mass injection pre-compressor cooling, wherein such first-stage vehicle lifts and accelerates a second-stage vehicle to Mach 2.50, at which point the second-stage vehicle separates and continues to accelerate under its own power to a velocity of up to Mach 5.00 using hydrogen-fueled turboramjet engines. Herein, travel is considered antipodal if the vehicle is capable of 12,000 miles flight.

b. Space-travel, which is both low-cost and rapid, utilizing a second-stage rocket powered space flight vehicle which is launched from the above-described first-stage vehicle, wherein such first-stage vehicle lifts and accelerates the rocket powered space flight vehicle to Mach 2.50, at which point it separates and continues to accelerate under its own power until attaining Earth orbit. For heavier payloads, an intermediate rocket booster element can be added to provide additional thrust. For longer missions an on-orbit fuel depot can added to extend the times between which the space flight vehicle needs to return to Earth. The speed necessary to reach orbit is a function of the desired altitude according to the formula v=sqrt (Gm/r), where v is the horizontal velocity of the satellite, G is the gravitational constant, m is the mass of the Earth and r the distance from the center of the Earth.

The combination disclosed herein is highly innovative and includes multiple innovative sub-combinations (e.g., systems solely for air travel or space travel). The reader should appreciate the high-dimensionality of the design space, cost of iteration, unpredictability of developments in related science and engineering, and long-standing need for the present affordances, as these aspects serve to illustrate the difficulty of arriving at the present set of solutions to the problems described. Further, it should be emphasized that the present document includes multiple inventions. Distinct solutions are provided to distinct problems and the synergistic combination of those solutions in the present application should not be read as limiting the scope of the present techniques to systems which address every problem described or provide every solution herein. Subsets of the present techniques are themselves expected to stand alone as independently useful approaches.

### 1. Multiple Vehicle Integration

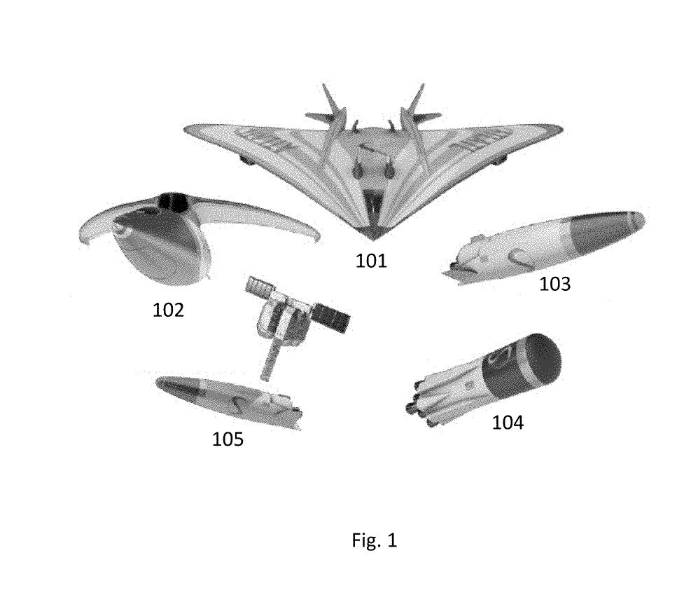

In certain embodiments, as shown in FIG. 1, the aerospace system comprises five different primary components: three winged vehicles and two supporting elements. These winged vehicles include a turbojet powered autonomous or remotely operated supersonic lifting and accelerating vehicle (the applicant terms this stage “Atlatl” and for purposes of this disclosure is termed “Take Off Vehicle”) 101, a hydrogen-fueled turboramjet powered high speed air transport vehicle (the applicant terms this stage “Hypersoar” and for purposes of this disclosure is termed “Atmospheric Cruise Vehicle”) 102, and a reusable space flight vehicle (the applicant terms this stage “Lightning” and for purposes of this disclosure is termed “Space Payload Vehicle”) 103. The supporting elements constitute an autonomously or remotely operated reusable rocket booster (the applicant terms this stage “Thunder” and for purposes of this disclosure is termed “Space Booster”) 104, and an on-orbit autonomously or remotely controlled fueling station (the applicant terms this stage “Propellant Depot” and for purposes of this disclosure is termed “Orbital Fuel Depot”) 105. Take Off Vehicle 101 is a supersonic aircraft platform used to lift and accelerate other vehicles and elements to high-altitude and high-speed, is powered by conventional turbojet engines and can be autonomously or remotely controlled. In this embodiment, Take Off Vehicle 101 is designed to carry a large and/or heavy external payload to altitude while accelerating it rapidly to approximately Mach 2.50, then separate safely from it in flight. Take Off Vehicle 101 has as a primary role to carry Atmospheric Cruise Vehicle 102, Space Payload Vehicle 103, or a combined Space Payload Vehicle 103-Space Booster 104 to a velocity of approximately Mach 2.5 and an altitude of approximately 50,000 feet above mean sea level, after which Atmospheric Cruise Vehicle 102 will separate and continue on its long-range high-speed trajectory within the atmosphere, or alternatively, Space Payload Vehicle 103 or the combined Space Payload Vehicle 103-Space Booster 104 will separate and continue on their trajectory to space. The various components of FIG. 1 are exemplary and neither the entirety of the design features nor appearances of the vehicles is the same in every embodiment.

In certain embodiments, Atmospheric Cruise Vehicle 102 is a second-stage Mach 5.0 long range hydrogen-fueled turboramjet powered, crewed airliner and air-freighter. In a preferred embodiment, Atmospheric Cruise Vehicle 102 can transport 100 passengers up to a velocity of Mach 5.00 and for a range of up to 12,500 statute miles, thereby connecting any two cities on Earth within four-hours or less.

In certain embodiments, Space Payload Vehicle 103 is a reusable second or third-stage (depending on payload mass) rocket powered, hydrogen-fueled space flight vehicle, which is autonomously or remotely operated. In these embodiments, Space Payload Vehicle 103 is a reusable unmanned space flight vehicle capable of carrying approximately 20,000 pounds of payload into Earth orbit. Space Payload Vehicle 103 has the ability to be refueled on-orbit to enable missions throughout the inner-solar system.

In certain embodiments, Space Booster 104 is a reusable hydrogen-fueled, rocket powered booster which is either autonomously or remotely operated, and which is mated to Space Payload Vehicle 103 to increase the payload mass which can be delivered to space by Space Payload Vehicle 103.

In certain embodiments, the Orbital Fuel Depot 105 is an on-orbit autonomously or remotely controlled fueling station which will receive, store and distribute propellant to Space Payload Vehicle 103 to extend its on-orbit duration and capability throughout cislunar space and the inner solar system.

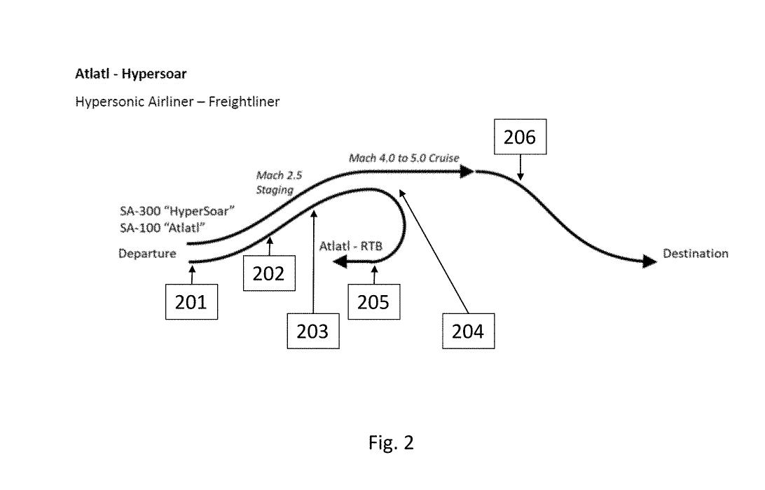

In certain embodiments, as shown in FIG. 2, Take Off Vehicle 101 carrying Atmospheric Cruise Vehicle 102, departs 201, climbs 202, and accelerates 203, then releases 204 (i.e., separates from, or stages) its external payload, thereafter returning 205 to the departure runway or other convenient location within approximately 45-minutes. In this embodiment, Atmospheric Cruise Vehicle 102 is the second-stage. This vehicle accelerates typically to higher Mach numbers, up to cruise speeds of approximately Mach 4.5-5.0 and continues on its flight path 206 to its destination city.

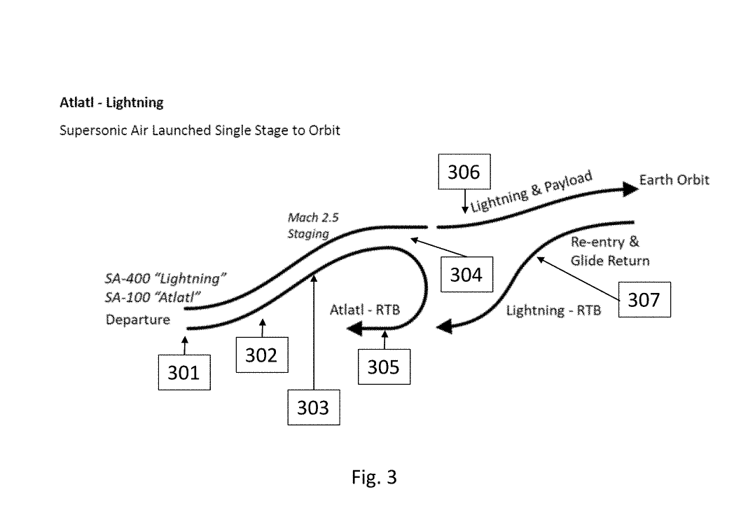

In certain embodiments, as shown in FIG. 3, Take Off Vehicle 101 carrying Space Payload Vehicle 103 departs 301, climbs 302, and accelerates 303 then releases 304 Space Payload Vehicle 103 in the atmosphere, thereafter returning 305 to the departure runway or other convenient location. In this case where Space Payload Vehicle 103 is the second stage, the vehicle continues 306 to accelerate on to an Earth orbit at any appropriate altitude. At an appropriate time, (e.g., after completion of its mission) Space Payload Vehicle 103 decelerates, re-enters Earth's atmosphere and glide returns 307 to a desirable runway.

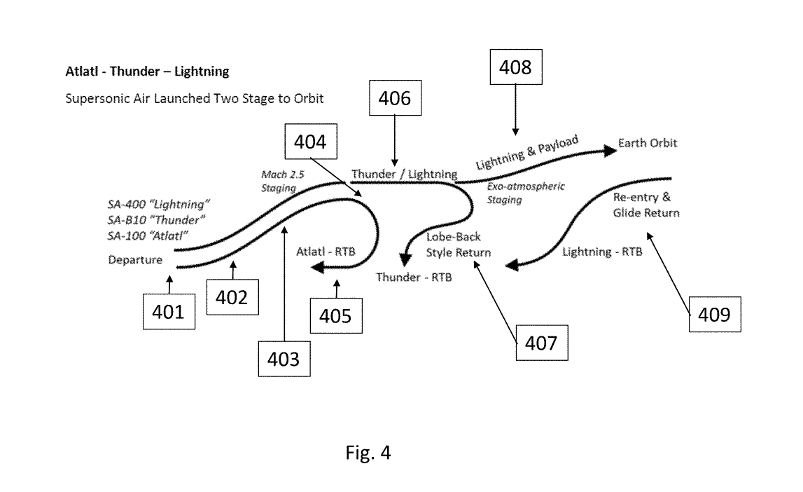

In certain embodiments as shown in FIG. 4, Take Off Vehicle 101 carries the combined Space Payload Vehicle 103-Space Booster 104 as the two the upper stages. Similarly with the embodiment involving only Space Payload Vehicle 103, Take Off Vehicle 101 carrying Space Payload Vehicle 103 and Space Booster 104 departs 401, climbs 402, and accelerates 403 then releases 404 Space Payload Vehicle 103 and Space Booster 104 in the atmosphere, thereafter returning 405 to the departure runway or other convenient location. In this case where Space Booster 104 is the second stage, the vehicle serves as a booster to continue to carry the payload and Space Payload Vehicle 103 to a higher altitude or higher orbit, or in certain situations when the payload is heavy enough that a second stage is needed. Space Booster 104 engages its rocket engines prior to the time of separation from Take Off Vehicle 101 and accelerates 406 the combined Space Payload Vehicle 103 and Space Booster 104 stages. At an appropriate time, (e.g., at the time rocket fuel has been fully spent,) Space Booster 104 separates from Space Payload Vehicle 103, decelerates, re-enters Earth's atmosphere and performs a lobe-back return 407 to a desirable landing area. Space Payload Vehicle 103 continues to accelerate 408 and enter its destination orbit. At an appropriate time (e.g., after completion of its mission) Space Payload Vehicle 103 decelerates, re-enters Earth's atmosphere and glide returns 409 to a desirable runway.

In certain embodiments, the winged vehicles Take Off Vehicle 101, Atmospheric Cruise Vehicle 102, and Space Payload Vehicle 103 will depart from, and return to any runway of 9,000 feet or greater.

In certain embodiments, Take Off Vehicle 101 can, when fitted with Atmospheric Cruise Vehicle 102, deliver 100 passengers anywhere on Earth within four-hours or less. Take Off Vehicle can also lift and accelerate Space Payload Vehicle 103 or the combined Space Payload Vehicle 103-Space Booster 104 rocket segments which will stage and continue on to orbit, returning to Earth at the completion of their respective missions.

This aerospace architecture provides for high utilization rates for each of the vehicles and elements which is key to profitability, as well as makes use of existing airports with their air-side infrastructure and runways, avoiding entirely the limitations, cost and inconvenience related to the few vertical rocket launch sites which are available globally. It is a system which adds novel aspects and features to the current systems of air transport and space access by applying novel airframe, propulsion and fuel technologies, to the specific requirements of mission altitudes, velocities and profiles; rather than attempting to make a single overly complex machine accomplish everything; which in the final analysis, it cannot do.

This aerospace architecture recognizes that for high-speed, high-altitude flight within the atmosphere, in order to go far and go fast, two constraints which have heretofore not been appreciated must be recognized and directly addressed. Firstly, in the preferred embodiments, the vehicles are staged. With present propulsion technology and fuel, it is not possible to carry all of the vehicle mass for the full duration of the flight without significantly reducing one or more of range, velocity or payload. Further to the point, it is also unnecessary as those components which work well low in the atmosphere at subsonic speeds are of no benefit in high-speed flight and high in the atmosphere. Consequently, in the preferred embodiment of the present disclosures, the aircraft is staged as operators have previously staged rockets (for similar reasons). Secondly, high-speed vehicles in many embodiments must use hydrogen as a fuel as has the greatest energy content, and its efficiency as a fuel is inelastic as a function of velocity. Both of these requirements, vehicle staging, and the use of hydrogen fuel, are incorporated, along with all the resulting ramifications for the design and operation of the aerospace system and its sub-components. A material additional benefit of staging is that it keeps the vehicles relatively simple, in that each vehicle or element uses only one type of engine and one type of fuel for propulsion, minimizing their complexity and minimizing the attendant risk. An additional benefit of using hydrogen as a fuel is that the byproduct of its combustion is water vapor. As Atmospheric Cruise Vehicle 102 replaces conventional airliners and air freighters, there exists the potential for economic expansion while reducing the emission of greenhouse gasses in the atmosphere. Further, adoption of Atmospheric Cruise Vehicle 102, which is an industrially relevant consumer of hydrogen, is expected to drive the production and distribution of hydrogen generally, making it economically feasible to deliver hydrogen to fueling stations for consumption by electric automobiles equipped with hydrogen fuel cells; this being a much more realistically scalable, and cleaner, way to power these electric vehicles than through the use of lithium battery technology.

### 2. Hydrogen Fuel

In certain embodiments, to achieve the advantages of both great speed and great distance, hydrogen is required as a propellant for Atmospheric Cruise Vehicle 102, where it is consumed in its turboramjet engines, as well as in Space Payload Vehicle 103 and Space Booster 104, where it is consumed in their rocket engines. Among the advantages of hydrogen as a fuel is its ability to power the turboramjet engines of Atmospheric Cruise Vehicle 102 over a wide range of speeds with little loss in efficiency. This is rarely the case for petroleum-based fuels regardless of the nature of the engine or combustion cycle.

### 3. Engines and Propulsion Systems

In certain embodiments, the second-stage Atmospheric Cruise Vehicle 102 employs hydrogen-fueled turboramjet engines, which are used during high-speed, high-altitude air-breathing flight within the atmosphere. Atmospheric Cruise Vehicle 102, in these embodiments, is a Mach 5.0 vehicle designed for high-speed, high-altitude, sustained commercial flight between city-pairs around the globe. It is mated to, then lifted and accelerated by, Take Off Vehicle 101, to approximately Mach 2.5, at which point Atmospheric Cruise Vehicle 102 separates (i.e., stages) from Take Off Vehicle 101 and continues to climb and accelerate under its own power. In this embodiment, Atmospheric Cruise Vehicle 102 requires two integrated primary propulsion systems (i.e., a combined-cycle engine) both of which use hydrogen as a fuel; a ramjet for supersonic flight, and an entirely new form of advanced turbojet engine driven by hydrogen expansion for subsonic flight. These two propulsion systems in combination form one engine which is an entirely new form of turboramjet, termed by the applicant as the “Cooljet” but for purposes of this disclosure is known as a “Liquid Hydrogen Cooled Turboramjet.”

In certain embodiments, the Liquid Hydrogen Cooled Turboramjet is a hydrogen-fueled turboramjet engine capable of providing thrust in a range of velocities from subsonic through Mach 5.0. Liquid Hydrogen Cooled Turboramjet is a combined-cycle engine which merges aspects of ramjet and turbojet engines. Because Atmospheric Cruise Vehicle 102 is launched at high-speed from Take Off Vehicle 101, Liquid Hydrogen Cooled Turboramjet initially employs its ramjet capabilities enabling high-speed, high-altitude long-range flight. As Atmospheric Cruise Vehicle 102 approaches its destination, descends and slows, there still exists a need for thrust in maneuvering during approach and landing, during which time the Liquid Hydrogen Cooled Turboramjet's hydrogen expansion driven turbomachinery is employed. At velocities above Mach 2.50, the majority of incoming airflow is diverted around the rotating machinery within the engine to protect the turbine section from high temperatures. Hydrogen fuel is mixed with the airflow and burned downstream of the diffuser and compressor. This afterburner arrangement can accelerate the vehicle to its cruise velocity. At subsonic speeds, airflow is passed through an inlet and compressed by a compressor, driven by a turbine, which is powered by a hydrogen cycle.

### 4. Take Off Vehicle

In certain embodiments, Take Off Vehicle 101 is an autonomous, remotely operated, or in some cases crewed, supersonic lifting and accelerating vehicle capable of carrying an external payload of up to 250,000 pounds to Mach 2.50 at which point it is released (i.e., staged). Take Off Vehicle 101 is powered by one or more turbojet engines with the addition of mass injection pre-compressor cooling. The Take Off Vehicle 101 planform allows it to take-off and return to any runway of 9,000 feet or greater.

In certain embodiments, Take Off Vehicle 101 is capable of multiple forms of control. While it is engaged with Atmospheric Cruise Vehicle 102, Take Off Vehicle 101 can be controlled and piloted by the crew of the Atmospheric Cruise Vehicle 102. In this manner, the combined vehicles (e.g., stack) is piloted as-if a single vehicle. The crew of Atmospheric Cruise Vehicle 102 can control Take Off Vehicle 101 by for instance, exercising control over the control surfaces, engines, landing gear, and any instrumentation within the Take Off Vehicle 101. In certain embodiments Take Off Vehicle 101 is an autonomous or remotely piloted vehicle. In these embodiments Take Off Vehicle 101 can be a simpler vehicle, and similar to drones and other unmanned aerial vehicles, in that there is no need for the systems necessary to support a crew or to anticipate interaction with a crew.

Take Off Vehicle 101 is designed to separate (i.e., stage) from Atmospheric Cruise Vehicle 102 or any other affixed payload. Separation will typically occur at approximately Mach 2.5. The benefits of separation at this speed are apparent. Separation below Mach 1.8 does not provide sufficient velocity for optimal Liquid Hydrogen Cooled Turboramjet utilization, nor optimal staging velocities for Space Payload Vehicle 103 or a combined Space Payload Vehicle 103-Space Booster 104 rocket stages to proceed to space; whereas separation above 2.70 unnecessarily stresses Take Off Vehicle 101 and its conventional turbojet propulsion machinery.

In certain embodiments, Take Off Vehicle 101 is powered by one or more afterburning turbojet engines producing approximately 30,000 lbs. of thrust each, to which is added mass injection pre-compressor cooling. This class of turbojet provides a thrust to weight ratio of approximately seven to one.

In these embodiments, Take Off Vehicle 101 is an autonomously or remotely piloted supersonic lifter and accelerator for any external payload up to 250,000 lbs., a supersonic lifter and accelerator first-stage for a high-speed high-altitude turboramjet powered second-stage (Atmospheric Cruise Vehicle 102), a supersonic lifter and accelerator for a rocket powered second-stage (Space Payload Vehicle 103), or rocket powered combined second and third-stage (Space Booster 104-Space Payload Vehicle 103); and is the first such vehicle to perform these roles from a standard runway of 9,000 feet or greater. Take Off Vehicle 101 is the first such vehicle capable of carrying a large external payload at supersonic velocities and the first such vehicle capable of delivering military payloads to space from a military runway within minutes.

### 5. Atmospheric Cruise Vehicle

In certain embodiments, Atmospheric Cruise Vehicle 102 is a Mach 5.00 cruise airliner and/or air freighter, designed for point-to-point travel anywhere on the globe (antipodal) in four-hours or less with sustained cruise at these speeds for these extended periods. It can be piloted by a two-person crew. It is powered by a plurality of Liquid Hydrogen Cooled Turboramjet hydrogen-fueled combined-cycle turboramjet engines.

In certain embodiments, Atmospheric Cruise Vehicle 102 for high-speed flight high in the atmosphere utilizes a parasol wing and Sears-Haack fuselage planform. In this arrangement, the wing of Atmospheric Cruise Vehicle 102 is above the fuselage. The Liquid Hydrogen Cooled Turboramjet engines are placed at the intersection of the wing and fuselage (the wing root) where air flow would otherwise be disrupted, such that the air is instead consumed by the engines. This arrangement also provides the maximum distance between the wing of Atmospheric Cruise Vehicle 102 to the wing of Take Off Vehicle 101 while the two vehicles are stacked, minimizing the air flow interference between the vehicles.

In certain embodiments, Take Off Vehicle 101 lifts and accelerates Atmospheric Cruise Vehicle 102 to an altitude of approximately 50,000 feet above mean sea level. The acceleration provided by Take Off Vehicle 101 provides sufficient initial velocity for the Liquid Hydrogen Cooled Turboramjet engines of the Atmospheric Cruise Vehicle 102 to begin operation prior to separation from Take Off Vehicle 101. The combined thrust of the Take Off Vehicle 101 and Atmospheric Cruise Vehicle 102 accelerate the combined stack until their separation at approximately Mach 2.50, at which point Atmospheric Cruise Vehicle 102 separates from Take Off Vehicle 101 and continues to accelerate under its own power up to a maximum velocity of Mach 5 at a maximum altitude of 120,000 feet above mean sea level.

In these embodiments, Atmospheric Cruise Vehicle 102 is the first hypersonic airliner and air-freighter, the first such vehicle with the capability to fly anywhere in the world (antipodal) non-stop in 4-hours or less, the first such vehicle to cruise between Mach 4.00 and Mach 5.00, the first such vehicle to cruise between 80,000 and 120,000 feet above mean sea level, the first such vehicle to do all the foregoing from a standard 9,000′ commercial runway, the first such vehicle to use cryogenic liquid molecular hydrogen as a fuel, the first such vehicle to use hydrogen-fueled turboramjets (Liquid Hydrogen Cooled Turboramjets) for propulsion, the first such vehicle to use a parasol wing for high-altitude high-speed flight, and the first such vehicle to be a second-stage only, that is it is launched from the lifter-accelerator first-stage vehicle Take Off Vehicle 101 in preferred embodiments. Atmospheric Cruise Vehicle 102 is the first such vehicle to use cryogenic liquid hydrogen for airframe and leading-edge cooling as well as vehicle heat balancing, the first such vehicle to create more than 4,000 new high-altitude, high-speed point-to-point city-pair routes, and the first such vehicle to accomplish all the foregoing with 100 passengers and associated baggage.

### 6. Space Payload Vehicle

In certain embodiments, Space Payload Vehicle 103 is a reusable supersonic air launched single stage to orbit vehicle and is the first true rocketship given that most of its propulsive force is provided by liquid hydrogen-fueled rocket engines installed onboard the vehicle. Space Payload Vehicle 103 is a separable payload section, separable from the Take Off Vehicle 101 and any Space Booster 104 Space Payload Vehicle 103 carries a payload to space, deploys its, then returns to Earth and lands on a commercial length runway of 9,000 feet or greater. Space Payload Vehicle 103 can be launched independently by Take Off Vehicle 101 or in conjunction with Space Booster 104 the latter being an intermediate-stage rocket powered booster allowing Space Payload Vehicle 103 to carry a greater payload mass to orbit.

In certain embodiments, Space Payload Vehicle 103 is a reusable space flight vehicle which carries and deploys its payload outside the Earth's atmosphere. It is air-launched as a second-stage or third-stage from Take Off Vehicle 101 and returns to land conventionally like an aircraft. For launch, Space Payload Vehicle 103 is mated (i.e., stacked) with Take Off Vehicle 101 after which Take Off Vehicle 101 propels the stack to approximately Mach 2.50. at the conclusion of this initial lift and acceleration phase, Space Payload Vehicle 103 will engage its rocket engines and then separate from Take Off Vehicle 101 after which Space Payload Vehicle 103 will continue into space, and Take Off Vehicle 101 will be autonomously or remotely piloted back to a desired runway. Space Payload Vehicle 103 can deliver payloads to orbit and for further transfer to anywhere in cislunar space or the inner solar system. Space Payload Vehicle 103 can continue to operate in space for long durations through the use of the Orbital Fuel Depot 105. For heavier payloads, Space Payload Vehicle 103 can be augmented with an additional intermediate rocket booster-stage, Space Booster 104. A significant advantage of this stacked multi-stage winged vehicle arrangement is that payloads can be launched to space from any of the many standard commercial length runways instead of relying on the limited number of rocket launch sites. This dramatically increases logistical flexibility, reduces costs, decreases turn-around time, and increases ease of use, among many other advantages.

In certain embodiments, Space Payload Vehicle 103 has a payload section of 30 feet in length, an approximately circular cross section, with a diameter of 15 feet, and a payload capacity of 20,000 lbs.

In these embodiments, Space Payload Vehicle 103 represents the first supersonic air launched reusable orbital stage vehicle, the first supersonic air launched single stage to orbit vehicle, the first rocket powered second-stage or third-stage orbital vehicle horizontally launched from a supersonic first-stage vehicle, Take Off Vehicle 101, and the first true rocketship given that most of its propulsion is internal to the vehicle.

### 7. Space Booster

In certain embodiments, Space Booster 104 is a reusable supersonic air launched second-stage hydrogen-fueled and rocket powered booster. Space Booster 104 is a separable booster segment, separable from the Lift Off Vehicle 101 and the Space Payload Vehicle 103. Space Booster 104 is intended to augment the performance of Space Payload Vehicle 103. Space Booster 104 uses the same hydrogen-fueled rocket engines as Space Payload Vehicle 103. Space Booster 104 is reusable and upon return to Earth lands vertically-propulsively.

In these embodiments, Space Booster 104 represents the first supersonic air launched reusable second-stage rocket booster, the first hydrogen-fueled rocket powered second-stage horizontally launched from a supersonic first-stage, Take Off Vehicle 101, and the first rocket booster component creating a supersonic air launched two stage to orbit (SAL-TSTO) vehicle stack.

### 8. Orbital Fuel Depot

In certain embodiments, the Orbital Fuel Depot 105 acts as a fuel storage and distribution station stationed in Earth orbit. It is comprised of a permanent in-space frame on which propellant modules that can be placed or removed for return to Earth and recharging. The Orbital Fuel Depot 105 will handle liquid hydrogen, liquid oxygen, liquid helium, liquid nitrogen, monomethyl hydrazine, nitrogen tetroxide oxidizer and hydrazine. Assembly, disassembly and operations will be robotic. The Orbital Fuel Depot 105 extends Space Payload Vehicle 103 commercial capabilities throughout cislunar space and the inner solar system and extends flight durations.

In these embodiments, the Orbital Fuel Depot 105 represents the first on-orbit fuel depot, the first fuel depot to allow freedom of operations throughout the inner solar system without returning to Earth for refueling, the first on-orbit depot to handle any and all of liquid hydrogen, liquid oxygen, liquid helium, liquid nitrogen, monomethyl hydrazine, nitrogen tetroxide oxidizer and hydrazine.

### Other Aspects of the System

Certain aspects of this disclosure include a multi-stage aerospace system comprising a first-stage vehicle that lifts and accelerates and is capable of achieving velocities of Mach 2.5, the first-stage vehicle powered by at least one turbine engine, and capable of autonomous and remote control; and a second-stage atmospheric flight vehicle capable of velocities of Mach 5.0, the second-stage atmospheric flight vehicle powered by at least one hydrogen-fueled turboramjet engine, and capable of carrying an internal payload; wherein the first-stage vehicle is adapted to support the second-stage atmospheric flight vehicle, as the first-stage vehicle reaches velocities sufficient to launch the second-stage atmospheric flight vehicle, and the second-stage atmospheric flight vehicle is capable of travel 12,000 miles.

Certain aspects of this disclosure include the system discussed above, wherein: the second-stage atmospheric flight vehicle is adapted to carry a plurality of people or freight.

Certain aspects of this disclosure include the system discussed above further comprising: a space flight vehicle capable of carrying internal payloads; and the first-stage vehicle is adapted to support the space flight vehicle as the first-stage vehicle reaches velocities sufficient to launch the second-stage space flight vehicle, and the space flight vehicle is capable of reaching Earth orbit.

Certain aspects of this disclosure include the system discussed above, wherein at least one turboramjet is hydrogen-fueled.

Certain aspects of this disclosure include the system discussed above, wherein the second-stage atmospheric flight vehicle is capable of reaching altitude of at least 80,000 feet, and the space flight vehicle is capable of reaching at least Earth orbit.

Certain aspects of this disclosure include the system discussed above, wherein the first-stage vehicle is capable of horizontal take-off and landing from a runway of 9,000 or fewer feet.

Certain aspects of this disclosure include the system discussed above, wherein the second-stage atmospheric flight vehicle has a weight of at least 80,000 lbs. and the space flight vehicle has a weight of at least 10,000 lbs.

Certain aspects of this disclosure include the system discussed above, wherein the space flight vehicle comprises a separable booster element and a separable payload vehicle.

Certain aspects of this disclosure include a modular aerospace system having an atmospheric configuration and a space configuration comprising: a lifting and accelerating vehicle, an atmospheric flight vehicle, and a space flight vehicle, wherein: the atmospheric configuration is capable of flight in the atmosphere and comprises the lifting and accelerating vehicle configured to affix to the atmospheric flight vehicle, and the atmospheric flight vehicle has the ability to travel 12,000 miles; and the space configuration comprises the lifting and accelerating vehicle configured to affix to the space flight vehicle, and the space flight vehicle is capable of reaching Earth orbit.

Certain aspects of this disclosure include the modular aerospace system discussed above wherein the atmospheric flight configuration comprises engines capable of powering the lifting and accelerating vehicle to at least Mach 2.0 and the atmospheric flight vehicle to at least Mach 4.0.

Certain aspects of this disclosure include the modular aerospace system discussed above wherein the space flight configuration comprises a booster element and a space flight vehicle, wherein the booster element is capable of providing thrust and the space flight vehicle is capable of providing thrust and carrying an internal payload.

Certain aspects of this disclosure include the modular aerospace system discussed above, wherein while in the atmospheric configuration, the atmospheric flight vehicle has a weigh of at least 80,000 lbs. and the lifting and accelerating vehicle is capable of take-off and landing on a runway of 9,000 or fewer feet.

Certain aspects of this disclosure include the modular aerospace system discussed above, wherein the atmospheric flight vehicle is powered by a plurality of hydrogen-fueled turboramjet engines.

Certain aspects of this disclosure include the modular aerospace system discussed above, wherein the lifting and accelerating vehicle is capable of flight control both autonomously and remotely.

Certain aspects of this disclosure include the modular aerospace system discussed above, wherein the atmospheric flight vehicle has thrust provided by a plurality of hydrogen-fueled turboramjet engines and is configured to sustain flight for more than 30 minutes to achieve an of 80,000 feet above mean sea level or greater.

Certain aspects of this disclosure include a method of travel comprising: effectuating atmospheric flight through the steps of: taking off from a runway in a combined vehicle comprising two independently controllable vehicles, comprising a first-stage vehicle and a second-stage atmospheric vehicle carrying an internal payload and affixed to the first-stage vehicle; accelerating the first-stage vehicle to a speed greater than Mach 1.0; separating the second-stage atmospheric vehicle from the first-stage vehicle; accelerating the second-stage atmospheric vehicle to a speed greater than Mach 4.0; reaching in the second-stage atmospheric vehicle an altitude greater than 80,000 feet above mean sea level; and piloting the first-stage vehicle to the ground with autonomous control or remote control.

Certain aspects of this disclosure include the method disclosed above, further comprising effectuating space flight through the steps of taking off from a runway in a combined vehicle comprising two independently controllable vehicles, comprising a first-stage vehicle and a second-stage space vehicle carrying an internal payload and affixed to the first-stage vehicle; accelerating the first-stage vehicle to a speed greater than Mach 1.0; separating the second-stage space vehicle from the first-stage vehicle; accelerating the second-stage vehicle to a speed sufficient to attain Earth orbit; and piloting the first-stage vehicle to the ground with autonomous control or remote control.

Certain aspects of this disclosure include the method disclosed above, further comprising the steps of: prior to separating the second-stage atmospheric vehicle from the first-stage vehicle, engaging engines of the second-stage atmospheric flight vehicle; and prior to separating the second-stage space vehicle from the first-stage vehicle, engaging engines of the second-stage space flight vehicle.

Certain aspects of this disclosure include the method disclosed above, wherein the second-stage atmospheric flight vehicle comprises at least one hydrogen-fueled turboramjet engine.

Certain aspects of this disclosure include the method disclosed above, wherein the second-stage space flight vehicle comprises at least one hydrogen-fueled rocket engine.

### GENERAL DISCUSSION

The reader should appreciate that the present application describes several inventions. Rather than separating those inventions into multiple isolated patent applications, the applicants have grouped these inventions into a single document because their related subject matter lends itself to economies in the application process. Nonetheless, the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to cost constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art of reviewing this disclosure the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, (i.e., encompassing both “and” and “or.”) Terms describing conditional relationships (e.g., “in response to X, Y,” “upon X, Y,” “if X, Y,” “when X, Y,” and the like), encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”.) Such conditional relationships are not limited to consequences that instantly follow the antecedent obtaining, as some consequences may be delayed, and in conditional statements, antecedents are connected to their consequents, (e.g., the antecedent is relevant to the likelihood of the consequent occurring). Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property (i.e., each does not necessarily mean each and every). Limitations as to sequence of recited steps should not be read into the claims unless explicitly specified (e.g., with explicit language like “after performing X, performing Y,”) in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category.

What is claimed is:

1. A multi-stage aerospace system comprising:
a first-stage vehicle that lifts and accelerates and is capable of achieving velocities of Mach 2.5, the first-stage vehicle powered by at least one turbine engine, and capable of autonomous and remote control; and
a second-stage atmospheric flight vehicle capable of velocities of Mach 5.0, the second-stage atmospheric flight vehicle powered by at least one hydrogen-fueled turboramjet engine, and capable of carrying an internal payload;
wherein the first-stage vehicle is adapted to support the second-stage atmospheric flight vehicle, as the first-stage vehicle reaches velocities sufficient to launch the second-stage atmospheric flight vehicle, and the second-stage atmospheric flight vehicle is capable of travel 12,000 miles.

2. The system of claim 1, wherein:
the second-stage atmospheric flight vehicle is adapted to carry a plurality of people or freight.

3. The system of claim 1 further comprising:
a space flight vehicle capable of carrying internal payloads; and
the first-stage vehicle is adapted to support the space flight vehicle as the first-stage vehicle reaches velocities sufficient to launch the second-stage space flight vehicle, and the space flight vehicle is capable of reaching Earth orbit.

4. The system of claim 1, wherein at least one turboramjet is hydrogen-fueled.

5. The system of claim 3, wherein the second-stage atmospheric flight vehicle is capable of reaching altitude of at least 80,000 feet, and the space flight vehicle is capable of reaching at least Earth orbit.

6. The system of claim 1, wherein the first-stage vehicle is capable of horizontal take-off and landing from a runway of 9,000 or fewer feet.

7. The system of claim 3, wherein the second-stage atmospheric flight vehicle has a weight of at least 80,000 lbs. and the space flight vehicle has a weight of at least 10,000 lbs.

8. The system of claim 3, wherein the space flight vehicle comprises a separable booster element and a separable payload vehicle.

9. A modular aerospace system having an atmospheric configuration and a space configuration comprising:
a lifting and accelerating vehicle, an atmospheric flight vehicle, and a space flight vehicle, wherein:
the atmospheric configuration is capable of flight in the atmosphere and comprises the lifting and accelerating vehicle configured to affix to the atmospheric flight vehicle, and the atmospheric flight vehicle has the ability to travel 12,000 miles; and
the space configuration comprises the lifting and accelerating vehicle configured to affix to the space flight vehicle, and the space flight vehicle is capable of reaching Earth orbit.

10. The modular aerospace system of claim 9 wherein the atmospheric flight configuration comprises engines capable of powering the lifting and accelerating vehicle to at least Mach 2.0 and the atmospheric flight vehicle to at least Mach 4.0.

11. The modular aerospace system of claim 9 wherein the space flight configuration comprises a booster element and a space flight vehicle, wherein the booster element is capable of providing thrust and the space flight vehicle is capable of providing thrust and carrying an internal payload.

12. The modular aerospace system of claim 9, wherein while in the atmospheric configuration, the atmospheric flight vehicle has a weigh of at least 80,000 lbs. and the lifting and accelerating vehicle is capable of take-off and landing on a runway of 9,000 or fewer feet.

13. The modular aerospace system of claim 9, wherein the atmospheric flight vehicle is powered by a plurality of hydrogen-fueled turboramjet engines.

14. The modular aerospace system of claim 9, wherein the lifting and accelerating vehicle is capable of flight control both autonomously and remotely.

15. The modular aerospace system of claim 9, wherein the atmospheric flight vehicle has thrust provided by a plurality of hydrogen-fueled turboramjet engines and is configured to sustain flight for more than 30 minutes to achieve an of 80,000 feet above mean sea level or greater.

16. A method of travel comprising:
effectuating atmospheric flight through the steps of:
taking off from a runway in a combined vehicle comprising two independently controllable vehicles, comprising a first-stage vehicle and a second-stage atmospheric vehicle carrying an internal payload and affixed to the first-stage vehicle;
accelerating the first-stage vehicle to a speed greater than Mach 1.0;
separating the second-stage atmospheric vehicle from the first-stage vehicle;
accelerating the second-stage atmospheric vehicle to a speed greater than Mach 4.0;
reaching in the second-stage atmospheric vehicle an altitude greater than 80,000 feet above mean sea level; and
piloting the first-stage vehicle to the ground with autonomous control or remote control.

17. The method of claim 16, further comprising:
effectuating space flight through the steps of
taking off from a runway in a combined vehicle comprising two independently controllable vehicles, comprising a first-stage vehicle and a second-stage space vehicle carrying an internal payload and affixed to the first-stage vehicle;
accelerating the first-stage vehicle to a speed greater than Mach 1.0;
separating the second-stage space vehicle from the first-stage vehicle;
accelerating the second-stage vehicle to a speed sufficient to attain Earth orbit; and
piloting the first-stage vehicle to the ground with autonomous control or remote control.

18. The method of claim 17, further comprising the steps of:
prior to separating the second-stage atmospheric vehicle from the first-stage vehicle, engaging engines of the second-stage atmospheric flight vehicle; and
prior to separating the second-stage space vehicle from the first-stage vehicle, engaging engines of the second-stage space flight vehicle.

19. The method of claim 18 wherein the second-stage atmospheric flight vehicle comprises at least one hydrogen-fueled turboramjet engine.

20. The method of claim 19 wherein the second-stage space flight vehicle comprises at least one hydrogen-fueled rocket engine
